(19) United States
(12) Patent Application Publication
(10) Pub. No.: US 2024/0070649 A1
(43) Pub. Date: Feb. 29, 2024

(54) MOBILE WALLET MANAGEMENT OF DIGITAL TOKENS

(71) Applicant: FAROVERSE, INC., Palo Alto, CA (US)

(72) Inventors: Madhusudhan Vudali, Saratoga, CA (US); Kamesh Raghavendra, Bengaluru (IN); T.M. Ravi, Portola Valley, CA (US)

(21) Appl. No.: 18/072,413

(22) Filed: Nov. 30, 2022

(30) Foreign Application Priority Data
Aug. 31, 2022 (IN) 202211049753

(51) Int. Cl. G06Q 20/36; G06Q 20/32; G06Q 20/38; G06Q 30/0207

(52) U.S. Cl. CPC G06Q 20/36; G06Q 20/326; G06Q 20/387; G06Q 20/389; G06Q 30/0239

(57) ABSTRACT

Embodiments provided a distributed computer system and a method of managing one or more non-fungible tokens (NFTs) using a mobile wallet system that is hosted using a mobile computing device. Various embodiments support using a Mobile Wallet Pass to represent a digital token and its utility outside of Web3 and/or Blockchain systems, software, or context; digitally linking an anonymous, unique digital token to an anonymous, unique Mobile Wallet Pass; de-linking and expiring the Mobile Wallet Pass when the original digital token is transferred from one Crypto-Wallet to another; communicating with token-holders via mobile-phone based push notifications that are presented on the Mobile Wallet Pass; manifesting the utilities of the digital token in relevant contexts using the Mobile Wallet Pass; enabling the token-holder to provide Personally Identifiable Information to the token-issuer using the Mobile Wallet Pass and claim additional utilities from the token-issuer; applying segmentation to digital tokens and presenting different utilities via the Mobile Wallet Pass; unlocking a utility based on their Web2 identity using the Mobile Wallet Pass.

### BENEFIT CLAIM

This application claims the benefit of India patent application 202211049753, filed Aug. 31, 2022, the entire contents of which are hereby incorporated by reference for all purposes as if fully set forth herein.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright or rights whatsoever. © 2022 Faroverse, Inc.

### TECHNICAL FIELD

One technical field of the present disclosure is computer-implemented methods and systems for managing digital tokens, including but not limited to non-fungible tokens (NFTs) that are associated with blockchains. Another technical field is management and use of digital wallets.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Digital tokens are a mechanism for users to own assets in various digital environments, including marketplaces, games, and metaverses. Some of these tokens are created and traded in a decentralized manner on blockchains (such as Ethereum, Solana, Flow, etc.) while others are created and traded under the auspices of centralized entities (such as Apple App Store, Roblox, Minecraft, etc.) These tokens have three characteristics that are relevant for this disclosure: They are unique and can be proven to be so. They are anonymous—per se, the ownership of the token does not identify the token-holder. They are transferable (either through a sale or as a gift).

These digital tokens are usually connected to valuable utilities to the current token-holder. These could be transactional (e.g., event tickets, coupons) or loyalty-/membership-related (e.g., exclusive offers, access to new products) or a combination thereof. The utilities could be periodically updated by the token-issuer. The utilities are exercised in digital, physical, or mobile environments, typically separate and outside the original context of the token purchase or issue. As a first example, a utility of a branded digital avatar is the ability to claim a discount in a physical store. As a second example, a utility of a NFT from a musician is the backstage pass at a concert.

While digital tokens of these types have attracted wide use, management of digital tokens, for the average consumer, continues to be inefficient and complex. Accessing and presenting digital tokens, for the average consumer, requires many technical steps and familiarity with multiple different software systems and/or online systems. Consequently, accessing and presenting a particular digital token at the right time to obtain a benefit, in a convenient amount of time, continues to be difficult. There is an acute need in the field of managing digital assets for improved techniques to access, inspect, present, and otherwise manage digital tokens.

### SUMMARY OF THE INVENTION

The appended claims may serve as a summary of the invention.

### BRIEF DESCRIPTION OF THE DRAWINGS

In the drawings:

FIG. 1 illustrates an example distributed computing system with which an embodiment can be implemented.

FIG. 2 illustrates an example computer system with which an embodiment can be implemented.

### DETAILED DESCRIPTION OF EXAMPLE EMBODIMENTS

In the following description, for the purposes of explanation, numerous specific details are set forth to provide a thorough understanding of the present invention. It will be apparent, however, that the present invention may be practiced without these specific details. In other instances, well-known structures and devices are shown in block diagram form to avoid unnecessarily obscuring the present invention.

The text of this disclosure, in combination with the drawing figures, is intended to state in prose the algorithms that are necessary to program a computer to implement the claimed inventions, at the same level of detail that is used by people of skill in the arts to which this disclosure pertains to communicate with one another concerning functions to be programmed, inputs, transformations, outputs and other aspects of programming. That is, the level of detail set forth in this disclosure is the same level of detail that persons of skill in the art normally use to communicate with one another to express algorithms to be programmed or the structure and function of programs to implement the inventions claimed herein.

Embodiments are described in sections according to the following outline:
A. General Overview
B. Example Distributed Computer System and Process
   1. Usage Of Mobile Wallet Pass As A Representation Of NFT And Associated Utility
   2. Anonymous, Unique Linkage Between NFT And Its Corresponding Mobile Wallet Pass
   3. De-Link And Expire Mobile Wallet Pass When The Ownership Of Original NFT Changes
   4. Ability To Communicate With Token-Holder Via The Mobile Wallet Pass For Customer Relationship Management
   5. Ability To Manifest The Utilities Of The Digital Token In Relevant Contexts Using Mobile Wallet Pass
   6. Ability To Reveal Personally Identifiable Information To The Token Issuer For Customer Relationship Management
   7. Ability To Token-Issuer To Apply Segmentation To Their Digital Tokens And Mobile Wallet Passes
C. Implementation Example—Computer System And Computer-Readable Media

A. General Overview

The following claims may serve as summaries of aspects of the invention. In various embodiments, the disclosure implements or provides:
1. The usage of a Mobile Wallet Pass (e.g., Apple Wallet on iOS, or Google Wallet on Android) to represent a digital token and its utility outside of Web3 and/or Blockchain systems, software, or context.
2. The ability to digitally link an anonymous, unique digital token to an anonymous, unique Mobile Wallet Pass.
3. The ability to de-link and expire the Mobile Wallet Pass when the original digital token is transferred (gifted or sold) from one Crypto-Wallet to another.
4. The ability to communicate with token-holders via mobile-phone based push notifications that are presented on the Mobile Wallet Pass.
5. The ability to manifest the utilities of the digital token in relevant contexts using the Mobile Wallet Pass, including but not limited to: Geo-fenced near a location of relevance (e.g., event ticket near a stadium, coupon near a store); or time-relevant (e.g., reminder before event).
6. The ability to enable the token-holder to provide Personally Identifiable Information to the token-issuer using the Mobile Wallet Pass and claim additional utilities from the token-issuer.
7. The ability of the token-issuer to apply segmentation to their digital tokens and present different utilities via the Mobile Wallet Pass. Segmentation can take several forms. Product-based segmentation can occur depending on the type of digital tokens being collected or purchased. Audience-based segmentation can occur depending on the inferred and opted-in data provided by the pass-holder.
8. The ability of the token holder to unlock a utility based on their Web2 identity using the Mobile Wallet Pass.

B. Example Distributed Computer System and Process

In one embodiment, computer-implemented wallet management elements are deployed using mobile computing devices or other computing devices that are coupled, through networks, to cloud-based computing services that implement digital tokens, digital token support services, and/or digital token management functions, including but not limited to NFTs and blockchains. For example, an embodiment can be implemented in the context of a larger distributed computer system having the following characteristics.

First, NFTs that are created, stored and managed on presently available blockchains inherently include or are associated with metadata. NFT standards define metadata attributes and formats as part of the standard. This metadata digitally stores various pieces of information about the NFT, including web-links.

Next, a User has access to a Crypto-Wallet that allows the user to transact on the blockchain (e.g., buy/sell currency, buy/sell digital tokens). MetaMask or CoinBase Wallet are popular Crypto-Wallets that could be used in association with an embodiment. The User has access to a Crypto-Wallet that allows the user to sign-in to a website or app. The User also has access to a mobile computing device that has a digital wallet installed. Examples include Apple Wallet on iOS and Google Wallet on Android.

In one embodiment, a computer-implemented wallet management system comprises an NFT System, a Mobile-Wallet System, and a Wallet Analytics System. The NFT System (termed an “NFTSys” herein) comprises a computer system, process, programmatic method, set of computer-executable instructions, or other software elements that are configured or programmed to create, deploy, and track NFTs and their ownership on public decentralized blockchains or centralized metaverse platforms. In an embodiment, the NFTSys is programmed to create an NFT and its associated metadata. The metadata is immutably associated with the NFT. In an embodiment, the NFTSys is programmed to include a mobile wallet pass link created in an MWSys as part of the NFT metadata. In an embodiment, the NFTSys is programmed to deploy an NFT on a blockchain using a SmartContract or upload the NFT into a centralized metaverse platform. In an embodiment, the NFTSys is programmed to track ownership of an NFT by directly querying the blockchain or the centralized metaverse platform, or by listening to transaction events from blockchains and metaverse platforms.

In an embodiment, the Mobile-Wallet System (termed an “MWSys” herein) comprises a process, programmatic method, set of computer-executable instructions, or other software elements that is configured or programmed to create, serve, and update mobile-wallet passes. In an embodiment, the MWSys is programmed to create various types of mobile wallet passes-loyalty, store-card, and generic passes that can be customized. In an embodiment, the MWSys is programmed to create clickable mobile wallet pass links that can be distributed (in websites, apps, social media, etc.) In an embodiment, the MWSys is programmed to deliver a pass to the user's mobile device when the user clicks a mobile wallet pass link. In an embodiment, the MWSys is programmed to insert a unique serial number when a pass is served. In an embodiment, the MWSys is programmed to encode geo-location and time-relevant information to a mobile wallet pass. In an embodiment, the MWSys is programmed to issue Near-Field Communication enabled passes for contactless usage. In an embodiment, the MWSys is programmed to send mobile push notifications to user's device and deliver updates to mobile wallet passes.

In an embodiment, the Wallet Analytics System (WASys) is programmed to receive NFT-related data, including NFT token id, wallet public key, transaction id, and NFT metadata from the NFTSys. In an embodiment, the WASys is programmed to receive Mobile Wallet Pass-related data, including pass serial number, pass type, pass metadata, and contextual relevance data from the MWSys. In an embodiment, the WASys is programmed to receive any external data, including pass serial number, any customer PII data, visit data, engagement data, sales data, from the issuer's Customer Relationship Management system or similar systems. In an embodiment, the WASys is programmed to combine all of the above data keyed by token-id, pass serial number, and any PII data to provide customer segmentation and analysis.

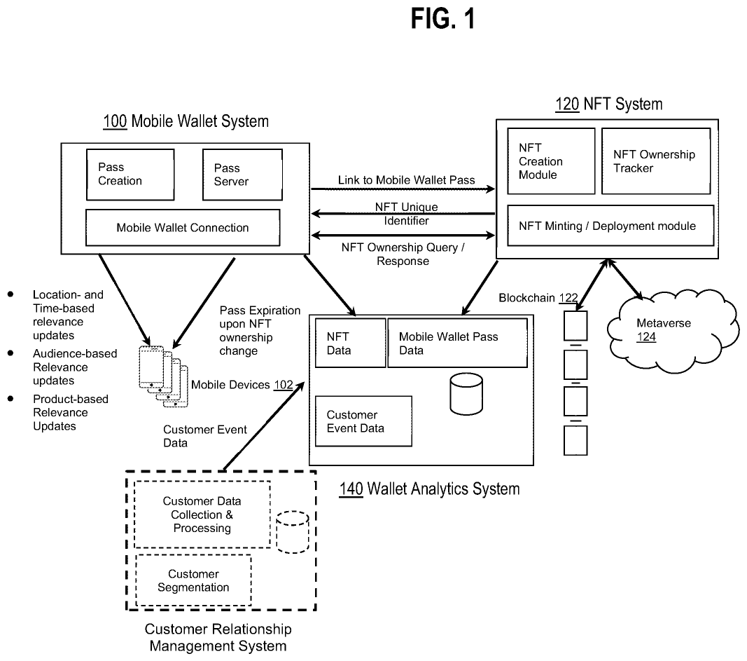

FIG. 1 illustrates an example distributed computing system with which an embodiment can be implemented. In an embodiment, a Mobile Wallet System 100 comprises a pass creation module, pass server, and mobile wallet connection module, each of which can be implemented using different sequences or integrated sequences of stored program instructions. The Mobile Wallet System 100 is communicatively coupled, directly or indirectly via one or more networks, to an NFT System 120 that hosts or executes an NFT creation module, NFT ownership tracker, and NFT minting/deployment module. Both systems are also connected to a Wallet Analytics System 140 that is programmed to collate data from them as well as any external customer event data from the issuer of the NFTs. Each of the modules specified in this paragraph may comprise one or more sets of instructions, methods, functions, libraries, or other software elements that are configured or programmed to implement the functions that are described herein. The NFT System 120 is communicatively coupled to a blockchain 122 and optionally coupled to a metaverse 124, which can be implemented using cloud-based computing services.

Each of the Mobile Wallet System 100, NFT System 120, and Wallet Analytics System 140 can be implemented using one or more server computers and/or compute instances and storage instances in any of a private datacenter or public, online datacenter or cloud computing services, such as AMAZON AWS, MICROSOFT AZURE, GOOGLE CLOUD, etc. Instances of the Mobile Wallet System 100 are downloaded to and executed using mobile computing devices 102 in the form of a mobile application. The Mobile Wallet System 100 also interoperates, via API calls and/or push notifications, with native digital wallet programs or services on the mobile computing devices 102. Examples of native digital wallet programs include the APPLE WALLET app associated with APPLE IOS and the GOOGLE WALLET app associated with the ANDROID operating system.

In one embodiment, Mobile Wallet System 100 is programmed to execute the algorithms described in the pseudocode described in prose in this section and the following sections:
1. An issuer of a token at NFTSys 120 creates a generic Mobile Wallet Pass in the MWSys and encodes one or more utilities in the Mobile Wallet Pass.
2. The MWSys generates an electronic link to this Mobile Wallet Pass and transmits the link to the NFTSys 120, which is illustrated as an arrow between elements 100, 120 in FIG. 1. The link can be structured as a parameterized URL, an HTTP POST request with a unique identifier of the Mobile Wallet Pass in a payload of the request, or a string that encodes a call to an API of the MWSys and includes a unique nonce, encrypted token, or other unique identifier of the Mobile Wallet Pass. The specific structure of the link is not critical provided that the MWSys later can receive a copy of the link electronically and can parse or interpret the link to identify a unique Mobile Wallet Pass that the MWSys manages.
3. The issuer then creates an NFT and embeds the link to the Mobile Wallet Pass with the NFT.
4. An end-user mints, buys, or obtains the NFT from a marketplace or directly from the blockchain or a metaverse store.
5. The end-user accesses the NFT and accesses the Mobile Wallet Pass link that is embedded in the NFT.
6. When the end-user taps on the Mobile Wallet Pass link, a request is made to the MWSys. The request includes the token-id of the NFT, which is unique across the entire blockchain, as indicated by the “NFT Unique Identifier” arrow in FIG. 1.
7. The MWSys queries the NFTSys to confirm that NFT with token-id is still owned by the end-user requesting the Mobile Wallet Pass.
8. NFTSys verifies ownership in real-time by querying the blockchain 122 or metaverse 124 for the current owner of the token-id. The “NFT Ownership Query/Response” arrow of FIG. 1 represents a message exchange of steps 7, 8. “Real-time,” in this context, means that the NFTSys transmits the query to the blockchain 122 or metaverse 124 without any significant delay and during a time in which the MWSys is waiting for a reply to its query to the NFTSys. Presuming that blockchain 122 or metaverse 124 confirms ownership, the NFTSys transmits a response to the MW Sys that confirms the ownership.
9. In response to the NFTSys confirming the ownership, the MWSys generates a unique Local Pass as a response and inserts the token-id as the unique serial number for that Local Pass. When the Local Pass is generated, the NFT and the Mobile Wallet Pass are conjoined as the token-id from the blockchain is transmitted as the serial number of the Local Pass. The MWSys transmits the Local Pass to a mobile computing device 102 of the end-user. Alternatively, the Local Pass can be generated by the MWSys calling into a mobile wallet system or other system service of the mobile computing device 102 to requesting local creation of the Local Pass at the mobile computing device 102.
10. The end-user installs the Local Pass in the mobile wallet of their mobile computing device 102.

Through the foregoing process, a token issuer, the Mobile Wallet System, and an end user of a mobile computing device 102 interoperate to persistently and uniquely bind an NFT, Mobile Wallet Pass, and Local Pass. Thereafter, the end user of the mobile computing device 102 can access the Local Pass via the native mobile wallet system of the mobile computing device 102 and present and use the Local Pass as a proxy for the Mobile Wallet Pass, thereby enabling the end user to access and use all utilities that have been defined for the Mobile Wallet Pass. With an associated NFT and blockchain storage, the Mobile Wallet Pass and its utilities effectively are immutable except for changes that the MWSys mediates. The linkage describes herein thus opens new possibilities for easier technical management of NFTs and related utilities, which in turn enables mobile computing devices 102 and their end users to use a new class of applications, functions, and features, as further described in other sections.

In an embodiment, the MWSys can be programmed to process ownership changes as follows.
1. When NFT ownership changes, the NFTSys is alerted.
2. The NFTSys transmits an electronic digital message specifying an ownership change event to the MWSys. The event includes the token-id of the NFT that now has a new owner.
3. The MWSys queries the Wallet Analytics System 140 to find a MobileWallet Pass having a serial number that is the same as the token-id and sends a pass-expiration notification to the mobile computing device 102 using native push-notification services.
4. The mobile wallet app in the mobile computing device 102 processes this push-notification and expires the associated mobile wallet pass.

B.1. Usage of Mobile Wallet Pass as a Representation of NFT and Associated Utility

Embodiments can be programmed to implement a plurality of system functions according to the algorithms that are described in prose in this section and the six (6) other sections that follow.

In one embodiment, an NFT issuer or seller defines one or more utilities that apply to an NFT when the NFT is created on the NFTSys. For example, a utility associated with an NFT could be a digital coupon or offer specifying a particular level or amount of discount for a particular product and/or store, or a utility could define the NFT as an event ticket. In an embodiment, once one or more utilities have been defined, the systems herein are programmed to translate the utilities into Mobile Wallet Passes that are stored in the user's mobile wallet. Translation can be programmed in several ways and can include transmitting or invoking system calls of system services or a local mobile wallet system of the mobile computing device 102 to create one or more ancillary passes that are added to a local mobile wallet. In one example, using Apple's PassKit, a coupon utility is created as a Coupon Pass that is installed in the user's iOS Apple Wallet. More generally, the Apple PassKit and Google Wallet APIs accept programmatic calls to create membership passes, loyalty passes, coupon passes, and event ticket passes. The APIs also allow the creation of generic passes for additional customization.

In an embodiment, the Wallet Analytics System 140 is programmed to create and store a mobile wallet pass with a unique association or 1:1 mapping between the mobile wallet pass and an NFT. In an embodiment, the MWSys is programmed to request and download a core NFT thumbnail image from the NFT via the NFTSys, then digitally store the image or a reference to the image on the front-side of the Mobile Wallet Pass by writing the image using a separate call to the PassKit or Wallet API, thereby giving the user a ready visual reference to the NFT. A Mobile Wallet Pass in Apple Wallet has features such as thumbnail image, logo image, and strip image on the front-side of the pass. Using Apple PassKit APIs, these images can be programmatically inserted in the pass.

Each Mobile Wallet Pass can be customized for relevance for the type of utility. For example, an event ticket can provide a reminder alert and can be geo-fenced to the event location. Using Apple PassKit, the passes can be updated based on relevance triggers such as Location or Time of the device on which the pass is resident.

In an embodiment, the MWSys hosts the passes using its Pass Server and using digital data storage, including any of directly attached storage, networked storage, or cloud-based storage. The MWSys is programmed to implement security controls that allow only the owner of the NFT to access a pass. In an embodiment, the Apple Wallet app manages the ownership via a unique device-generated identifier that is relayed to the MWSys.

In an embodiment, when the NFT is minted via the NFTSys, the link to the MWSys is included in the metadata of the NFT. In an embodiment, the owner of the NFT can tap on the MWSys link directly from the NFT. In an embodiment, when the user taps on the MWSys link, the user is prompted to sign-in with their Crypto-Wallet. A Crypto-Wallet such as MetaMask allows the user to sign-in to a website or app to access the relevant content.

Based on the Crypto-Wallet sign-in, the NFTSys can verify the ownership of the NFTs associated with the Crypto-Wallet's public key and present the linked utilities of the NFTs. The sign-in allows the website or app to receive the public key of the user. Using that public key of the user, the NFTSys can query the blockchain, for example using Etherscan.io, to verify ownership of the NFT. In an embodiment, the linked utilities are presented as Mobile Wallet Passes that the user can add to their mobile wallet on their device. The mobile wallet pass can be updated to include the unique URL to the NFT, creating the connection between the NFT and the Mobile Wallet Pass.

B.2 Anonymous, Unique Linkage Between NFT and ITS Corresponding Mobile Wallet Pass

NFTs are unique items with specific identifiers on the blockchain ledger or in a centralized metaverse. When an NFT is owned, the NFT resides in a Crypto-Wallet where the identity of the user is anonymous by design. Only the Public Key of the wallet is available to external systems. The Private Key is available only to the owner of the Crypto-Wallet.

A pass in a mobile digital wallet carries a unique, device-generated identifier used to manage the pass. Both Apple Wallet and Google Wallet generate these identifiers for iOS and Android, respectively.

In an embodiment, a Mobile Wallet Pass can be anonymous, by design, with explicit user permission required to share any personally identifiable information with the issuer.

By issuing a Mobile Wallet Pass for an NFT, embodiments digitally form an anonymous, unique linkage between the Mobile Wallet Pass and the NFT, extending key characteristics of the NFT such as uniqueness and anonymity into the Mobile Wallet Pass.

B.3 De-Link and Expire Mobile Wallet Pass when the Ownership of Original NFT Changes

In an embodiment, the NFTSys can track the current ownership of NFT by querying the blockchain for the NFT, which is represented by its unique blockchain identifier, and by querying the owner, which the public key of the Crypto-Wallet represents. Alternatively, a SmartContracts system can post ownership-change events to the NFTSys. A blockchain scan service such as Etherscan.io can be used to query the blockchain for various events, including ownership.

When the NFTSys detects the change of ownership, any associated utilities should be removed from the corresponding Mobile Wallet Pass. Therefore, in an embodiment, in response to a change of ownership, the NFTSys is programmed to direct the MWSys to update and expire the corresponding Mobile Wallet Pass via a push notification. After the update and expiration, any utilities associated with an NFT become unusable. In an embodiment, the Apple Push Notification Service is used to direct the MWSys to make such updates.

B.4 Ability to Communicate with Token-Holder Via the Mobile Wallet Pass for Customer Relationship Management

NFTs are digital tokens and do not have associated functionality for any communication. In an embodiment, the Mobile Wallet Pass associated with the NFT created by the NFTSys can be designed to carry additional messages and interactions. In an embodiment, the MWSys is programmed to update passes in Apple Wallet or Google Wallet by calling the Apple PassKit or Google Wallet API, invoking an update function, and transmitting a message with the call to the update function. Thus, in an embodiment, the mobile wallet system can be programmed for the mobile wallet system transmitting a call to an update function of the digital wallet of the mobile computing device, the call comprising a message and an invocation of a function to post the message in the local pass.

Additional messages can be general product information or updates. Additional interactions can be delivered as URLs that the user can tap to access. For example, additional interactions could comprise a URL to a webpage announcing upcoming product launch or an iOS App Store link to download and install an app.

In an embodiment, the MWSys is programmed to transmit such additional messages and interactions via Push Notifications; they also can be posted on the back of the pass. In this context, the position and appearance of the back of a Mobile Wallet Pass may vary in different implementations. For example, in an Apple Wallet, data and/or metadata forming the back of a pass is accessible and viewable using a visual graphical “( . . . )” widget that is displayed in an upper corner of a pass. The Apple PassKit and Google Wallet APIs are used to make these updates.

In one embodiment, this capability allows the NFT issuer to communicate with the token-holder for customer relationship management purposes.

B.5 Ability to Manifest the Utilities of the Digital Token in Relevant Contexts Using Mobile Wallet Pass

NFTs can have one or more associated utilities that need to be presented to the token-holder in a context that is relevant to the utility. Each utility is expressed in metadata that is associated with an NFT. For example, a utility specification can be defined in a smart contract that is associated with an NFT or external to the NFT and linked to it. However, by delivering the utility in a Mobile Wallet Pass, an embodiment can use native capabilities of a mobile wallet app to present the utility at the right time and place. Relevant contexts can be defined in metadata that is associated with or part of the mobile wallet pass. For example, Apple iOS allows up to ten locations to be associated with a pass. Thus, an embodiment can be programmed for creating and storing, in the mobile wallet pass, metadata specifying one or more locations and times during which the one or more utilities are usable.

For example, consider an NFT that has a coupon utility associated with it. The relevant context for the coupon is the physical store at which the coupon can be redeemed. As another example, consider an NFT that has an event ticket associated with it. The relevant context for the event ticket is the physical location where the event is held as well as the time of the event. By creating a linked Mobile Wallet Pass to an NFT, any utilities can be presented in relevant contexts. One embodiment can rely on existing programming of the native mobile wallet of the mobile computing device 102 to present the utilities only at a location or time that is specified in the metadata.

In an embodiment, the Mobile Wallet Pass is digitally stored and encoded in a JSON object including relevant contextual information. Example context attributes include geographical boundaries, lat-long data or other location data to support geo-fencing, time zone values and time-date values for reminders, start dates, end dates, or expiration dates. In this form at, the context data can be updated as necessary. An update can comprise the MWSys calling an API function of a host Mobile Wallet on Apple iOS or Google Android.

B.6 Ability to Reveal Personally Identifiable Information to the Token Issuer for Customer Relationship Management

NFTs and digital tokens are anonymous by design. In an embodiment, Mobile Wallet Passes can also be anonymous. However, the MWSys and Mobile Wallet Pass also can be programmed to provide an opt-in for the pass-holder to reveal personal information to the pass issuer. In one embodiment, the token-holder can exercise the option to reveal PII as necessary. For example, on the back of the Mobile Wallet Pass, the token issuer can post a URL that takes the user to a webpage where they can register their personal information. The Personal Identifiable Information can be used by token-issuer to log and update pre-existing Customer Relationship Management systems as necessary.

B.7 Ability to Token-Issuer to Apply Segmentation to their Digital Tokens and Mobile Wallet Passes

NFTs and digital tokens are anonymous by design, while they have associated metadata describing the NFT. The metadata is the description of the NFT and its traits. In an embodiment, the Mobile Wallet Passes are also anonymous by design and comprise additional descriptive metadata. In one embodiment, attributes of Mobile Wallet Pass metadata comprise the type of pass and its required data elements (e.g., for a coupon, the value of the discount), location attributes, date and time reminders, and other values.

In addition, an issuer can capture interactions with a Mobile Wallet Pass, such as in their point-of-sale system or a Customer Relationship Management (CRM) system. Depending on the type of interaction, the issuer can track and collect various data elements associated with the Mobile wallet pass. For example, a coupon pass could be connected to the resulting sale of a product or lack thereof.

By linking a digital token to the Mobile Wallet Pass, the NFTSys and MWSys can share the linked data with the Wallet Analytics System 140. Both the NFT and the Mobile Wallet Pass possess attributes and values of the attributes; furthermore, as a Mobile Wallet Pass is used, additional metadata is created and stored. When the NFT and Mobile Wallet Pass are linked as described herein, the attribute data can be combined and used together for audience segmentation in digital advertising systems, customer data platform (CDP) systems, or CRMs. Combined with any customer event data from the issuer's customer relationship management system, the Wallet Analytics System can create a set of data that covers the entire customer journey from purchase of the NFT to downloading the Mobile Wallet Pass and engaging with the issuer's products and systems. This combined data can be used for customer segmentation and analysis across the entire customer journey. Audience segmentation can be applied to digital tokens and to the mobile wallet passes to create/issue digital tokens and/or provide new utilities.

C. Implementation Example—Computer System and Computer-Readable Media

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques or may include digital electronic devices such as at least one application-specific integrated circuit (ASIC) or field programmable gate array (FPGA) that is persistently programmed to perform the techniques or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

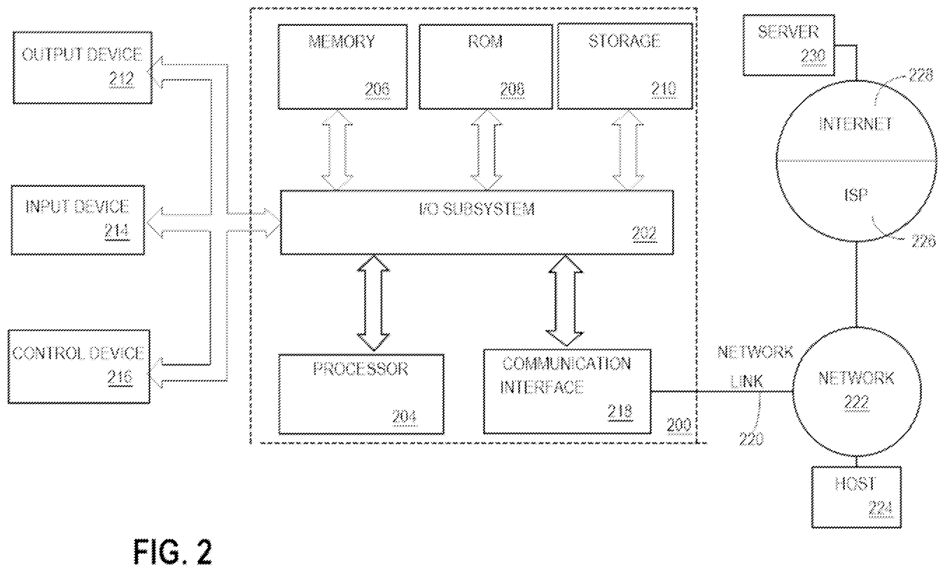

FIG. 2 is a block diagram that illustrates an example computer system with which an embodiment may be implemented. In the example of FIG. 2, a computer system 200 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 200 includes an input/output (I/O) subsystem 202 which may include a bus and/or other communication mechanism(s) for communicating information and/or instructions between the components of the computer system 200 over electronic signal paths. The I/O subsystem 202 may include an I/O controller, a memory controller and at least one I/O port. The electronic signal paths are represented schematically in the drawings, for example as lines, unidirectional arrows, or bidirectional arrows.

At least one hardware processor 204 is coupled to I/O subsystem 202 for processing information and instructions. Hardware processor 204 may include, for example, a general-purpose microprocessor or microcontroller and/or a special-purpose microprocessor such as an embedded system or a graphics processing unit (GPU) or a digital signal processor or ARM processor. Processor 204 may comprise an integrated arithmetic logic unit (ALU) or may be coupled to a separate ALU.

Computer system 200 includes one or more units of memory 206, such as a main memory, which is coupled to I/O subsystem 202 for electronically digitally storing data and instructions to be executed by processor 204. Memory 206 may include volatile memory such as various forms of random-access memory (RAM) or other dynamic storage device. Memory 206 also may be used for storing temporary variables or other intermediate information during execution of instructions to be executed by processor 204. Such instructions, when stored in non-transitory computer-readable storage media accessible to processor 204, can render computer system 200 into a special-purpose machine that is customized to perform the operations specified in the instructions.

Computer system 200 further includes non-volatile memory such as read only memory (ROM) 208 or other static storage device coupled to I/O subsystem 202 for storing information and instructions for processor 204. The ROM 208 may include various forms of programmable ROM (PROM) such as erasable PROM (EPROM) or electrically erasable PROM (EEPROM). A unit of persistent storage 210 may include various forms of non-volatile RAM (NVRAM), such as FLASH memory, or solid-state storage, magnetic disk or optical disk such as CD-ROM or DVD-ROM and may be coupled to I/O subsystem 202 for storing information and instructions. Storage 210 is an example of a non-transitory computer-readable medium that may be used to store instructions and data which when executed by the processor 204 cause performing computer-implemented methods to execute the techniques herein.

The instructions in memory 206, ROM 208 or storage 210 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or no SQL, an object store, a graph database, a flat file system or other data storage.

Computer system 200 may be coupled via I/O subsystem 202 to at least one output device 212. In one embodiment, output device 212 is a digital computer display. Examples of a display that may be used in various embodiments include a touch screen display or a light-emitting diode (LED) display or a liquid crystal display (LCD) or an e-paper display. Computer system 200 may include other type(s) of output devices 212, alternatively or in addition to a display device. Examples of other output devices 212 include printers, ticket printers, plotters, projectors, sound cards or video cards, speakers, buzzers or piezoelectric devices or other audible devices, lamps or LED or LCD indicators, haptic devices, actuators or servos.

At least one input device 214 is coupled to I/O subsystem 202 for communicating signals, data, command selections or gestures to processor 204. Examples of input devices 214 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 216, which may perform cursor control or other automated control functions such as navigation in a graphical interface on a display screen, alternatively or in addition to input functions. Control device 216 may be a touchpad, a mouse, a trackball, or cursor direction keys for communicating direction information and command selections to processor 204 and for controlling cursor movement on display 212. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 214 may include a combination of multiple different input devices, such as a video camera and a depth sensor.

In another embodiment, computer system 200 may comprise an internet of things (IoT) device in which one or more of the output device 212, input device 214, and control device 216 are omitted. Or, in such an embodiment, the input device 214 may comprise one or more cameras, motion detectors, thermometers, microphones, seismic detectors, other sensors or detectors, measurement devices or encoders and the output device 212 may comprise a special-purpose display such as a single-line LED or LCD display, one or more indicators, a display panel, a meter, a valve, a solenoid, an actuator or a servo.

When computer system 200 is a mobile computing device, input device 214 may comprise a global positioning system (GPS) receiver coupled to a GPS module that is capable of triangulating to a plurality of GPS satellites, determining and generating geo-location or position data such as latitude-longitude values for a geophysical location of the computer system 200. Output device 212 may include hardware, software, firmware and interfaces for generating position reporting packets, notifications, pulse or heartbeat signals, or other recurring data transmissions that specify a position of the computer system 200, alone or in combination with other application-specific data, directed toward host 224 or server 230.

Computer system 200 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 200 in response to processor 204 executing at least one sequence of at least one instruction contained in main memory 206. Such instructions may be read into main memory 206 from another storage medium, such as storage 210. Execution of the sequences of instructions contained in main memory 206 causes processor 204 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage 210. Volatile media includes dynamic memory, such as memory 206. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 202. Transmission media can also take the form of acoustic or light waves, such as those generated during radio-wave and infra-red data communications.

Various forms of media may be involved in carrying at least one sequence of at least one instruction to processor 204 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 200 can receive the data on the communication link and convert the data to a format that can be read by computer system 200. For instance, a receiver such as a radio frequency antenna or an infrared detector can receive the data carried in a wireless or optical signal and appropriate circuitry can provide the data to I/O subsystem 202 such as place the data on a bus. I/O subsystem 202 carries the data to memory 206, from which processor 204 retrieves and executes the instructions. The instructions received by memory 206 may optionally be stored on storage 210 either before or after execution by processor 204.

Computer system 200 also includes a communication interface 218 coupled to bus 202. Communication interface 218 provides a two-way data communication coupling to network link(s) 220 that are directly or indirectly connected to at least one communication networks, such as a network 222 or a public or private cloud on the Internet. For example, communication interface 218 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 222 broadly represents a local area network (LAN), wide-area network (WAN), campus network, internetwork or any combination thereof. Communication interface 218 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 218 sends and receives electrical, electromagnetic or optical signals over signal paths that carry digital data streams representing various types of information.

Network link 220 typically provides electrical, electromagnetic, or optical data communication directly or through at least one network to other data devices, using, for example, satellite, cellular, Wi-Fi, or BLUETOOTH technology. For example, network link 220 may provide a connection through a network 222 to a host computer 224.

Furthermore, network link 220 may provide a connection through network 222 or to other computing devices via internetworking devices and/or computers that are operated by an Internet Service Provider (ISP) 226. ISP 226 provides data communication services through a world-wide packet data communication network represented as internet 228. A server computer 230 may be coupled to internet 228. Server 230 broadly represents any computer, data center, virtual machine or virtual computing instance with or without a hypervisor, or computer executing a containerized program system such as DOCKER or KUBERNETES. Server 230 may represent an electronic digital service that is implemented using more than one computer or instance and that is accessed and used by transmitting web services requests, uniform resource locator (URL) strings with parameters in HTTP payloads, API calls, app services calls, or other service calls. Computer system 200 and server 230 may form elements of a distributed computing system that includes other computers, a processing cluster, server farm or other organization of computers that cooperate to perform tasks or execute applications or services. Server 230 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server 230 may comprise a web application server that hosts a presentation layer, application layer and data storage layer such as a relational database system using structured query language (SQL) or no SQL, an object store, a graph database, a flat file system or other data storage.

Computer system 200 can send messages and receive data and instructions, including program code, through the network(s), network link 220 and communication interface 218. In the Internet example, a server 230 might transmit a requested code for an application program through Internet 228, ISP 226, local network 222 and communication interface 218. The received code may be executed by processor 204 as it is received, and/or stored in storage 210, or other non-volatile storage for later execution.

The execution of instructions as described in this section may implement a process in the form of an instance of a computer program that is being executed, and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 204. While each processor 204 or core of the processor executes a single task at a time, computer system 200 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-implemented method comprising:
receiving at a mobile wallet system, from an issuer computer associated with an issuer of a digital token and associated with a non-fungible token (NFT) system, a request to create a mobile wallet pass and specifying one or more utilities;
creating and storing, in a digital storage repository of the mobile wallet system, the mobile wallet pass wherein the mobile wallet pass is encoded with the one or more utilities in digital storage associated with the mobile wallet system;
transmitting, from the mobile wallet system to the issuer computer, an electronic link to the mobile wallet pass;
receiving, from a mobile computing device, a request specifying a token identifier of an NFT, and in response, transmitting a query to the NFT system to confirm that an end user associated with the mobile computing device then currently owns the NFT associated with the token identifier and receiving a response from the NFT system confirming ownership;
generating, in a digital wallet of the mobile computing device, a local pass and inserting the token identifier as a unique serial number of the local pass.

2. The computer-implemented method of claim 1, further comprising the mobile wallet system transmitting a query to the NFT system to confirm that an end user associated with the mobile computing device then currently owns the NFT associated with the token identifier.

3. The computer-implemented method of claim 2, further comprising the NFT system transmitting a query to a blockchain or metaverse to confirm ownership of the NFT, receiving a response that confirms ownership of the NFT, and transmitting a response to the mobile wallet system confirming ownership of the NFT.

4. The computer-implemented method of claim 1, further comprising the issuer computer creating the NFT and embedding the link to the mobile wallet pass in the NFT.

5. The computer-implemented method of claim 1, further comprising:
receiving, at the mobile wallet system, an ownership change event specifying the token identifier;
querying the digital storage repository to identify the mobile wallet pass having the serial number that matches the token identifier;
transmitting, using a push notification to the mobile computing device, a pass expiration notification that specifies the serial number.

6. The computer-implemented method of claim 1, wherein the one or more utilities comprise any of (a) a digital coupon or offer specifying a particular level or amount of discount for a particular product and/or store, and (b) an event ticket, the method further comprising requesting the mobile computing device to create one or more ancillary passes in the digital wallet, each of the one or more ancillary passes corresponding to one of the one or more utilities.

7. The computer-implemented method of claim 6, further comprising calling one or more of APPLE PAS SKIT or GOOGLE WALLET APIs to create any of membership passes, loyalty passes, coupon passes, and event ticket passes.

8. The computer-implemented method of claim 1, further comprising:
requesting and downloading a core NFT thumbnail image from the NFT via the NFT system;
writing the core NFT thumbnail image to a front-side image of the mobile wallet pass in the digital wallet.

9. The computer-implemented method of claim 1, further comprising the mobile wallet system transmitting a call to an update function of the digital wallet of the mobile computing device, the call comprising a message and an invocation of a function to post the message in the local pass.

10. The computer-implemented method of claim 1, further comprising creating and storing, in the mobile wallet pass, metadata specifying one or more locations and times during which the one or more utilities are usable.

11. One or more non-transitory computer-readable storage media storing one or more sequences of instructions which, when executed using one or more processors, cause the one or more processors to execute:
receiving at a mobile wallet system, from an issuer computer associated with an issuer of a digital token and associated with a non-fungible token (NFT) system, a request to create a mobile wallet pass and specifying one or more utilities;
creating and storing, in a digital storage repository of the mobile wallet system, the mobile wallet pass wherein the mobile wallet pass is encoded with the one or more utilities in digital storage associated with the mobile wallet system;
transmitting, from the mobile wallet system to the issuer computer, an electronic link to the mobile wallet pass;
receiving, from a mobile computing device, a request specifying a token identifier of an NFT, and in response, transmitting a query to the NFT system to confirm that an end user associated with the mobile computing device then currently owns the NFT associated with the token identifier and receiving a response from the NFT system confirming ownership;
generating, in a digital wallet of the mobile computing device, a local pass and inserting the token identifier as a unique serial number of the local pass.

12. The one or more non-transitory computer-readable storage media of claim 11, further comprising sequences of instructions which, when executed using one or more processors, cause the one or more processors to execute: the mobile wallet system transmitting a query to the NFT system to confirm that an end user associated with the mobile computing device then currently owns the NFT associated with the token identifier.

13. The one or more non-transitory computer-readable storage media of claim 12, further comprising sequences of instructions which, when executed using one or more processors, cause the one or more processors to execute: the NFT system transmitting a query to a blockchain or metaverse to confirm ownership of the NFT, receiving a response that confirms ownership of the NFT, and transmitting a response to the mobile wallet system confirming ownership of the NFT.

14. The one or more non-transitory computer-readable storage media of claim 11, further comprising sequences of instructions which, when executed using one or more processors, cause the one or more processors to execute: the issuer computer creating the NFT and embedding the link to the mobile wallet pass in the NFT.

15. The one or more non-transitory computer-readable storage media of claim 11, further comprising sequences of instructions which, when executed using one or more processors, cause the one or more processors to execute:
receiving, at the mobile wallet system, an ownership change event specifying the token identifier;
querying the digital storage repository to identify the mobile wallet pass having the serial number that matches the token identifier;
transmitting, using a push notification to the mobile computing device, a pass expiration notification that specifies the serial number.

16. The one or more non-transitory computer-readable storage media of claim 11, wherein the one or more utilities comprise any of (a) a digital coupon or offer specifying a particular level or amount of discount for a particular product and/or store, and (b) an event ticket, further comprising sequences of instructions which, when executed using one or more processors, cause the one or more processors to execute requesting the mobile computing device to create one or more ancillary passes in the digital wallet, each of the one or more ancillary passes corresponding to one of the one or more utilities.

17. The one or more non-transitory computer-readable storage media of claim 16, further comprising sequences of instructions which, when executed using one or more processors, cause the one or more processors to execute calling one or more of APPLE PAS SKIT or GOOGLE WALLET APIs to create any of membership passes, loyalty passes, coupon passes, and event ticket passes.

18. The one or more non-transitory computer-readable storage media of claim 11, further comprising sequences of instructions which, when executed using one or more processors, cause the one or more processors to execute:
requesting and downloading a core NFT thumbnail image from the NFT via the NFT system;
writing the core NFT thumbnail image to a front-side image of the mobile wallet pass in the digital wallet.

19. The one or more non-transitory computer-readable storage media of claim 11, further comprising sequences of instructions which, when executed using one or more processors, cause the one or more processors to execute: the mobile wallet system transmitting a call to an update function of the digital wallet of the mobile computing device, the call comprising a message and an invocation of a function to post the message in the local pass.

20. The one or more non-transitory computer-readable storage media of claim 11, further comprising sequences of instructions which, when executed using one or more processors, cause the one or more processors to execute creating and storing, in the mobile wallet pass, metadata specifying one or more locations and times during which the one or more utilities are usable.
